(19) United States
(12) Patent Application Publication
(10) Pub. No.: US 2026/0198462 A1
(43) Pub. Date: Jul. 16, 2026

(54) Device for Efficient Wax Capping Honey Extraction and Separation and Method of Operation

(71) Applicant: David James Laing, Hamilton Township, NJ (US)

(72) Inventor: David James Laing, Hamilton Township, NJ (US)

(21) Appl. No.: 19/561,573

(22) Filed: Mar. 10, 2026

Related U.S. Application Data
(60) Provisional application No. 63/775,332, filed on Mar. 21, 2025.

(51) Int. Cl. A01K 59/02; A01K 59/04; A01K 59/06

(52) U.S. Cl. CPC A01K 59/02; A01K 59/04; A01K 59/06

(57) ABSTRACT

The present invention relates to a device that is adapted to facilitate the efficient separation of honey from wax capping during the extraction process, thereby enhancing honey recovery, improving wax cleanliness, and reducing manual labor while maintaining a simple and practical design for widespread adoption. The device comprises a first frame assembly, a second frame assembly, and a third frame assembly. The device eliminates the need for manual straining or pressing, reducing labor and time consumption for beekeepers. The device offers a practical and affordable alternative to expensive commercial honey and wax separation machinery. The device offers a practical and affordable alternative to expensive commercial honey and wax separation machinery. The device is interchangeable with fit standard honey extractors, thereby allowing small-scale and hobbyist beekeepers to use it without additional costly equipment.

### FIELD OF THE INVENTION

The present invention relates to the field of wax-capping honey extraction, and specifically, relates to a device that is adapted to facilitate the efficient separation of honey from wax capping during the extraction process, thereby enhancing honey recovery, improving wax cleanliness, and reducing manual labor while maintaining a simple and practical design for widespread adoption.

### BACKGROUND

Honey is a natural sweet substance produced by honeybees from the nectar of flowers. It serves as a primary food source for bees and is widely consumed by humans due to its nutritional benefits and medicinal properties. The process of honey production involves the collection of nectar by worker bees, its enzymatic transformation, and storage in honeycombs. Beekeepers harvest honey by extracting it from honeycombs while preserving the integrity of the hive structure. Honey capping extraction is an essential step in honey harvesting, as it involves the removal of the thin layer of beeswax that seals the honey-filled cells within the honeycomb. These wax capping protect the stored honey and must be carefully separated to allow the extraction process to proceed. Once removed, honey capping contains residual honey, which beekeepers seek to recover efficiently while also managing the wax for reuse or further processing.

Once the honey is deposited into the cells, the bees fan it to reduce the water content to 18%, completing the honey production process. The bees then cap the honeycomb with a thin layer of wax to seal and preserve the honey, ensuring it is properly stored and cured. This capped honeycomb is then harvested by beekeepers to extract the honey. The typical method for honey harvesting involves removing the honey-laden frames from the supers and decapping them, which is the process of removing the wax capping from the filled honeycomb cells. Beekeepers generally use tools such as scratching devices or heated knives to carefully remove the wax caps. During this decapping process, a byproduct referred to as “wax capping” is generated, which consists of a mixture of beeswax and honey.

Once the honeycomb has been decapped, the frames are placed into conventional honey extractors. These extractors, commonly radial or horizontal in design, are engineered to accept Langstroth frames and use centrifugal force to extract the honey from the decapped cells. The frames are spun within the extractor, causing the honey to be expelled from the combs and exposing it to extractor walls and collected at a bottom of a storage tank. Once the honey settles at the bottom, the honey gate is opened, allowing the honey to flow into a double-filter stainless steel screen. This filters out any debris and small pieces of wax, which are then discarded. The filters are placed on top of a 5-gallon bucket for collection. The honey is then further filtered through a fine cloth filter, such as a paint filter, before being ready for bottling.

The wax capping, which is removed both during the decapping of the honeycombs and from the top of the honey storage tanks, which contain a substantial quantity of honey. This mixture of wax and honey, often referred to as “wax capping,” is traditionally discarded or subjected to further processing. However, the presence of honey within the wax results in a lost opportunity to recover additional honey from the byproduct. Moreover, the honey does not degrade within the wax cappings, as it can last indefinitely. However, its nutritional value is destroyed during wax melting process, known as rendering if not removed from cappings. This process involves melting the wax in boiling water, allowing most of the debris and any residual honey now degraded, to settle at the bottom as the mixture cools. The wax then floats to the top and solidifies, while any remaining impurities stuck to the bottom are scraped off and re-rendered.

Traditional honey capping extraction methods rely on manual tools such as uncapping knives, heated blades, or mechanical uncappers to remove the wax layer from honeycombs. Beekeepers then collect the capping and attempt to extract the residual honey through straining or pressing. Large-scale commercial operations use corkscrew presses or centrifugal separation machines to process capping efficiently. However, these machines are expensive and unsuitable for small-scale beekeepers due to their high costs and space requirements.

Currently, large-scale honey-wax separation processes are employed by larger beekeepers using augers and specialized equipment to handle bulk quantities of wax capping. These systems auger the wax capping into large containers, where they are then processed in washing or melting bins to separate the remaining honey from the wax. While this process is effective for large operations, it is costly and inefficient for smaller beekeepers who typically manage fewer hives. For small to medium-sized beekeepers, who manage limited hive counts, often fewer than 300 hives.

As a result, smaller-scale beekeepers typically use reusable wooden or plastic frames within their hives. After honey is extracted from the frames, they are placed outside for the bees to clean off any residual honey. The frames, along with the wax comb, are then either reused and returned to the hive for the bees to refill. This loss of recoverable honey reduces overall extraction efficiency, thereby reducing overall yields. Additionally, the time required to process the wax cappings is increased due to the need for additional steps to separate the honey from the wax. This extended processing time results in higher labor costs and inefficiencies in the overall honey extraction process.

Traditionally, beehives utilize wooden or plastic frame structures that support a removable foundation upon which bees construct honeycomb. These frame systems are designed to permit removal of the honeycomb for extraction while preserving the structural integrity of the frame. After honey extraction, the frames and foundations may be reused within the hive. However, while such systems facilitate honey harvesting, they do not provide an efficient mechanism for recovering honey retained within removed wax cappings during the decapping process.

Therefore, there is a need for a device that effectively extracts liquid honey from the wax and other solids, and might not filter out debris or contaminants, thereby reducing mess and improving overall efficiency. There is also a need for a device that is interchangeable with fit standard honey extractors, thereby allowing small-scale and hobbyist beekeepers to use it without additional costly equipment. There is also a need for a device that offers three access mechanisms for user convenience and flexibility. There is also a need for a device that eliminates the need for manual straining or pressing, reducing labor and time consumption for beekeepers. Furthermore, there is also a need for a device that offers a practical and affordable alternative to expensive commercial honey and wax separation machinery.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments nor delineate the scope of any or all embodiments.

The present disclosure, in one or more embodiments, relates to a device that is adapted to facilitate the efficient separation of honey from wax capping during the extraction process, thereby enhancing honey recovery, improving wax cleanliness, and reducing manual labor while maintaining a simple and practical design for widespread adoption. The device effectively extracts honey from wax capping while keeping wax contained.

In one embodiment herein, the wax-capping honey separation device comprises a first frame assembly having a structural frame that defines a hollow structure that is configured to receive wax cappings containing residual honey. The device comprises at least two mesh members disposed on opposite sides of the structural frame. The at least two mesh members are configured to permit honey to pass outwardly from the hollow structure during centrifugal extraction while retaining the wax cappings within the hollow structure.

The structural frame includes at least two grooves formed along opposite sides of the structural frame, where each of the grooves define a respective side track. At least two sliders are slidably received within the respective grooves of the structural frame. The at least two sliders are configured to allow a user to be selectively translated between open position that permits insertion of wax cappings into the hollow structure and, a closed position that seals the hollow structure during centrifugal extraction. The structural frame includes at least two mesh members disposed on opposite sides of the structural frame. The mesh members are configured to permit honey to pass outwardly from the hollow structure during centrifugal extraction while retaining the wax cappings within the hollow structure.

In one embodiment, the at least two grooves are integrally formed with the structural frame and extend longitudinally along opposing sides of the structural frame. The at least two sliders are positioned on opposite sides of the structural frame such that wax cappings are insertable into the hollow structure from either side of the structural frame. Each of the sliders comprises at least one notch configured to receive a user's fingertip to facilitate manual translation of the sliders between the open position and the closed position.

In one embodiment, the at least two mesh members comprise at least one of stainless-steel mesh, food-grade polymer mesh, molded perforated screening, and perforated sheet material. Each mesh member may be fixedly disposed within a corresponding opening of the structural frame. The mesh members are configured to filter honey from the wax cappings during the centrifugal extraction process, ensuring a cleaner separation while retaining the wax cappings within the hollow structure.

In another embodiment herein, the device comprises a first frame assembly having a structural frame defining a hollow structure. The structural frame defines a hollow structure configured to receive wax cappings containing residual honey. The device comprises at least two mesh members that are disposed on opposite sides of the structural frame. The at least two mesh members are configured to permit honey to pass outwardly from the hollow structure during centrifugal extraction while retaining wax cappings within the hollow structure. Additionally, the device comprises at least two grooves and at least two grooves.

In one embodiment herein, the at least two grooves are formed along opposite sides of the structural frame. Each of the grooves defines a respective side track. The at least two sliders are slidably received within the respective grooves of the structural frame. The at least two sliders are configured to allow a user to be selectively translated between an open position that permits insertion of wax cappings into the hollow structure and a closed position that seals the hollow structure during centrifugal extraction. During the centrifugal extraction, honey passes through the mesh members while the wax cappings remain retained within the hollow structure.

Additionally, the mesh members comprise molded perforations integrally formed within the structural frame. The mesh members comprise at least one of stainless-steel mesh, food-grade polymer mesh, or perforated screening. The mesh members are fixedly disposed within a corresponding opening of the structural frame. The grooves are integrally formed within the structural frame. The sliders are removable from the grooves after centrifugal extraction to permit manual expulsion of wax cappings from the hollow structure.

According to another aspect, a method is disclosed for separating honey from wax cappings using the device. At one step, the user manually moves the sliders from the closed position to the open position to access the hollow structure. At another step, the user manually inserts the wax capping within the hollow structure of the structural frame. At another step, the user manually moves the sliders from the open position to the closed position to seal the hollow structure. At another step, the user positions the first frame assembly of the device within a honey extraction machine. Further, at another step, the one or more mesh members allow the honey to pass while retaining the wax cappings within the hollow structure during operation of the honey extraction machine.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1A illustrates a top schematic view of a device of a first frame assembly, in accordance with of the invention.

FIGS. 1B-1C illustrate cross-sectional views of the first frame assembly, in accordance with of the invention

FIG. 1D illustrates a side schematic view of the first frame assembly, in accordance with of the invention.

FIG. 1E illustrates a cross-sectional view of sliders, in accordance with of the invention.

FIG. 2 illustrates a flowchart of a method for extracting the honey from the wax capping by utilizing the first frame assembly, in accordance with of the invention.

FIG. 3A illustrates a top schematic view of a second frame assembly, in accordance with of the invention.

FIG. 3B illustrates a side schematic view of the second frame assembly, in accordance with of the invention.

FIG. 3C illustrates a schematic view of the second frame assembly with a snap-fit mechanism, in accordance with of the invention.

FIG. 4 illustrates a flowchart of a method for extracting the honey from the wax capping by utilizing the second frame assembly, in accordance with of the invention.

FIG. 5A illustrates a top schematic view of a third frame assembly, in accordance with of the invention.

FIG. 5B illustrates a right-side schematic view of the third frame assembly, in accordance with of the invention.

FIG. 5C illustrate a left-side schematic view of the third frame assembly, in accordance with of the invention.

FIG. 5D illustrate a right-side schematic view of the third frame assembly, in accordance with of the invention.

FIG. 5E illustrate a schematic view of the third frame assembly with a snap-fit mechanism, in accordance with of the invention.

FIG. 6 illustrates a flowchart of a method for extracting the honey from the wax capping by utilizing the third frame assembly, in accordance with of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

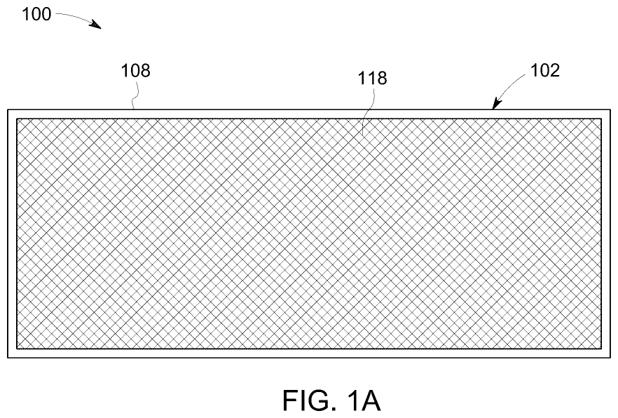

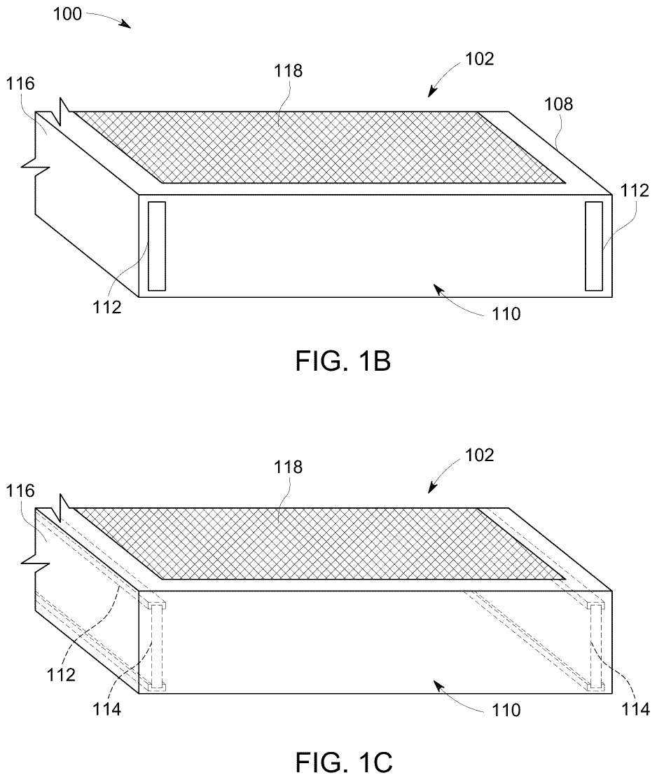

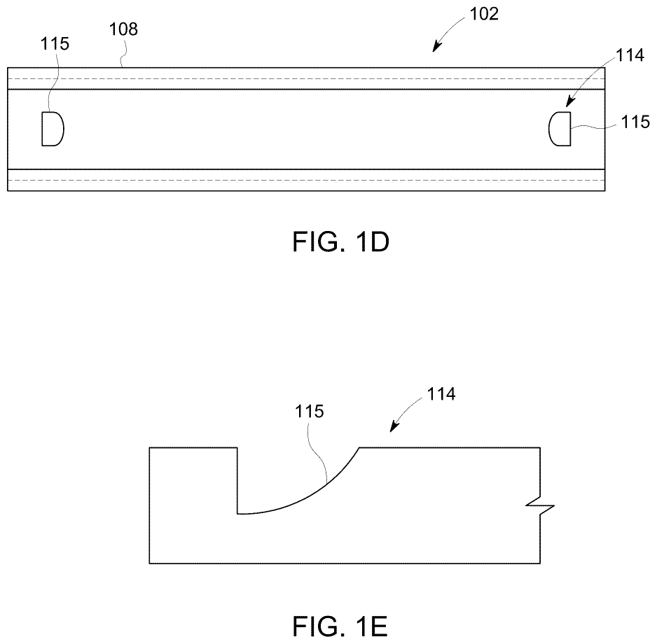

FIG. 1A refers to a top schematic view of a device 100 of a first frame assembly 102. The device 100 is interchangeable with fit standard honey extractors, thereby allowing small-scale and hobbyist beekeepers to use it without additional costly equipment. The device 100 offers three access mechanisms for user convenience and flexibility. The device 100 eliminates the need for manual straining or pressing, reducing labor and time consumption for beekeepers. The device 100 offers a practical and affordable alternative to expensive commercial honey and wax separation machinery.

In one embodiment herein, the first frame assembly 102 comprises a structural frame 108. The structural frame 108 is characterized by a hollow structure 110, which is specifically configured to receive wax capping during the honey extraction process. The hollow structure 110 allows for the insertion and extraction of the wax capping, which is essential for the efficient harvesting of honey.

In another embodiment herein, the first frame assembly 102 includes one or more mesh members 118. These mesh members 118 are positioned on both the top and bottom surfaces of the housing 108, forming a critical part of the honey extraction process. The mesh members 118 are configured to filter the honey from the wax cappings during the honey extraction process, thereby ensuring a cleaner separation. This ensures that the honey remains free of impurities, improving its quality and purity. The one or more mesh members 118 are constructed from a plastic material, which is chosen for its properties that facilitate the efficient extraction of honey from the wax capping. The use of plastic allows for a durable yet lightweight material that does not interfere with the honey extraction process, thereby ensuring optimal results. It also offers ease of cleanup due to the plastic frame material.

FIGS. 1B-1C refer to cross-sectional views of the first frame assembly 102. FIG. 1D refers to a side schematic view of the first frame assembly 102. In one embodiment herein, the structural frame 108 is configured by the hollow structure 110, which is specifically configured to receive wax capping during the honey extraction process. The hollow structure 110 allows for the insertion and extraction of the wax capping, which is essential for the efficient harvesting of honey. In one embodiment herein, the first frame assembly 102 comprises at least one groove 112 formed on opposing sides of the structural frame 108. The at least one groove 112 is dimensioned and configured to provide user access for the insertion of wax capping material into the hollow structure 110, thereby facilitating subsequent extraction processing. These grooves 112 are strategically placed to provide structural support and facilitate the movement of other components within the structural frame 108.

In one embodiment herein, the first frame assembly 102 comprises at least two sliders 114 that are slidably positioned within the respective groove 112 formed on the opposing sides of the structural frame 108. Additionally, the sliders 114 are supported by the grooves 112, which enable the sliders 114 to move smoothly within the structural frame 108. The movement of the sliders 114 is essential, as it can be adjusted by the user from an open position to a closed position. This movement allows for easy access to the hollow structure 110, thereby enabling the retention of the wax capping and ultimately aiding in the honey extraction process.

FIG. 1E refers to a cross-sectional view of the sliders 114. In one embodiment herein, each slider 114 is configured with at least two notches 115. The notches 115 are ergonomically configured to receive the user's fingertip, thereby facilitating manual actuation of the slider 114 between the open position and the closed position. Such actuation enables controlled sliding movement of the slider 114 within the corresponding grooves 112 formed on opposing sides of the structural frame 108, thereby selectively providing access to the hollow structure 110. This configuration permits the user to insert the wax capping into the hollow structure 110 and to remove the wax capping therefrom during operation.

In one embodiment herein, the open position refers to a configuration in which at least one slider 114 is displaced outwardly along the corresponding groove 112 such that an access opening to the hollow structure 110 is exposed, thereby allowing insertion or removal of wax cappings. Conversely, the closed position refers to a configuration in which the slider 114 is translated inwardly along the groove to cover or seal the access opening of the hollow structure 110, thereby retaining the wax cappings within the hollow structure 110 during operation of a centrifugal honey extractor. The movement between the open position and the closed position occurs through guided sliding motion along the grooves 112 formed in the frame assemblies, thereby ensuring controlled translation of the slider 114 while maintaining alignment with the hollow structure 110.

In one embodiment herein, the one or more mesh members 118 (as depicted in FIG. 1B) are positioned on both the top and bottom surfaces of the structural frame 108, thereby forming a critical part of the honey extraction process. The mesh members 118 ensure a cleaner separation of honey from the solids. This process is the use of ‘food-grade’ plastic in the screen and other processing equipment, which helps maintain the highest food safety standards, thereby ensuring that the honey remains safe for consumption throughout the entire removal process. The one or more mesh members 118 are constructed from a plastic material, which is chosen for its properties that facilitate the efficient extraction of honey from the wax capping. The use of plastic allows for a durable yet lightweight material. The housing 108 is designed with specific dimensions, at least 2 inches thick by at least 8 inches wide by at least 18 inches long. These dimensions are optimized to fit into the honey extractor machine for the honey extraction process.

The open position of the slider 114 is configured to be positioned within the hollow structure 110 of the housing 108. This position allows the slider 114 to remain securely in place, providing stability during the honey extraction process. The closed position of the slider 114 allows it to be drawn out from the hollow structure 110 of the structural frame 108. This feature enables the user to move the sliders 114 away from the first frame assembly 102, thereby gaining access to the hollow structure 110. This access is critical for retaining the wax capping, further facilitating the honey extraction process by providing a means to effectively manage the wax during extraction.

In one example, the slider 114 comprises elongated plates configured to translate along corresponding grooves 112. The grooves 112 may be configured as channel-shaped tracks, dovetail tracks, or rail-type guides that constrain the movement of the slider 114 in a linear direction. Additionally, the slider 114 may further include peripheral overlap edges, sealing lips, or compressible gasket elements that engage with adjacent portions of the first frame assembly 102 when the slider 114 is positioned in the closed position. Such engagement reduces leakage of wax fragments or honey during centrifugal extraction.

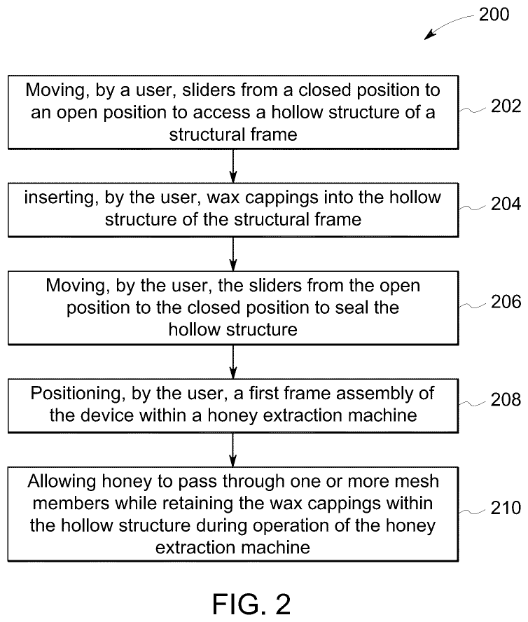

FIG. 2 refers to a flowchart 200 of a method for extracting the honey from the wax capping by utilizing the first frame assembly 102. At step 202, the user manually moves the sliders 114 from the closed position to the open position to access the hollow structure 110. At step 204, the user manually inserts the wax capping within the hollow structure 110 of the structural frame 108. At step 206, the user manually moves the sliders 114 from the open position to the closed position to seal the hollow structure 110. At step 208, the user positions the first frame assembly 102 of the device 100 within a honey extraction machine. Further, at step 210, the one or more mesh members 118 allow the honey to pass while retaining the wax cappings within the hollow structure 110 during operation of the honey extraction machine.

In one embodiment herein, the mesh members 118 may be formed from stainless steel wire mesh, polymer mesh, or perforated sheet metal, depending on durability and cleaning requirements. Additionally, the mesh members 118 size may range from 0.5 mm to 5 mm aperture diameter, although other mesh sizes may be employed depending on the characteristics of the wax cappings and honey viscosity. The mesh members 118 may be fixedly mounted, removably secured, or integrally formed with the first frame assembly 102 using fastening elements, welding, adhesive bonding, and molded integration.

During operation, wax cappings removed from honeycomb frames may be introduced into the hollow structure 110 when the sliders 112 are positioned in the open position. After loading, the sliders 112 are translated to the closed position to enclose the hollow structure 110. The first frame assembly 102 may then be placed within a centrifugal honey extractor, where rotational forces generated by the extractor cause liquid honey contained within the wax cappings to flow outwardly through the mesh members while the wax material remains retained within the hollow structure 110. This configuration allows simultaneous extraction and filtration, thereby separating honey from wax cappings while preventing wax debris from contaminating the extracted honey.

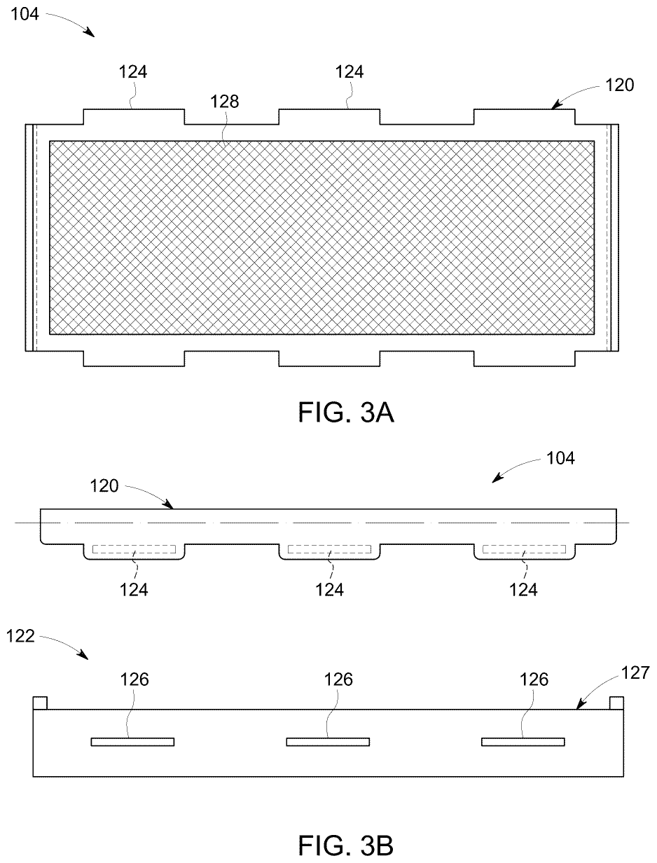

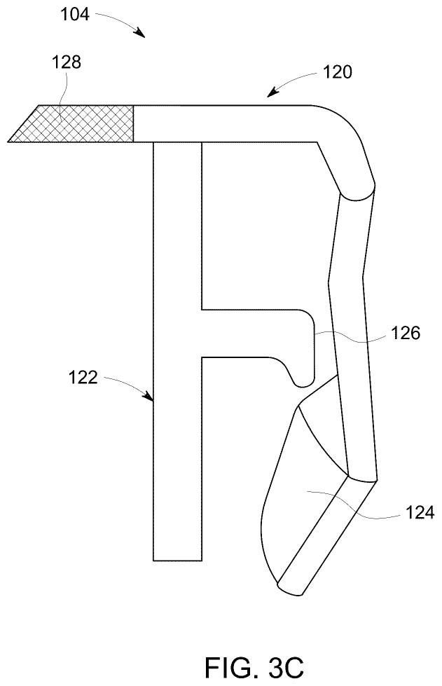

FIG. 3A refers to a top schematic view of a second frame assembly 104. In one embodiment herein, the second frame assembly 104 comprises a primary frame member 120 and a secondary frame member 122. In one embodiment herein, the primary frame member 120 is equipped with a plurality of coupling members 124, which are configured to interact with the secondary frame member 122. These coupling members 124 allow for secure attachment and detachment between the primary and secondary frame members (120, 122). The primary frame member 120 and secondary frame member 122 are designed with specific dimensions, at least 2 inches thick by at least 8 inches wide by at least 18 inches long. These dimensions are optimized to provide a compact yet effective structure, which fits into the honey extractor for the honey extraction process.

FIG. 3B refers to a side schematic view of the second frame assembly 104. In one embodiment herein, the secondary frame member 122 is detachably connected to the primary frame member 120 via the plurality of coupling members 124. These coupling members 124 are attached to a plurality of snap bulges 126 on the secondary frame member 122. The snap bulges 126 work in conjunction with the coupling members 124 to create a secure and easily detachable connection between the primary frame member 120 and the secondary frame member 122. The secondary frame member 122 is configured to receive the wax capping, facilitating the honey extraction process. Additionally, the secondary frame member 122 is designed with specific dimensions, at least 2 inches thick by at least 8 inches wide by at least 18 inches long. These dimensions are optimized to fit into the honey extractor machine for the honey extraction process.

The primary frame member 120 and secondary frame member 122 are both equipped with at least two screen meshes 128. The least two screen meshes 128 are configured to filter the honey from the wax cappings during the honey extraction process. This ensures that the extracted honey is clean and free from unwanted particles, improving its quality and purity. The at least two screen meshes 128 ensure a cleaner separation of honey from the solids. This process is the use of ‘food-grade’ plastic in the screen and other processing equipment, which helps maintain the highest food safety standards, thereby ensuring that the honey remains safe for consumption throughout the entire removal process.

In one embodiment herein, the two screen meshes 128 are constructed from plastic material, which is chosen for its durability and ability to withstand the conditions of the honey extraction process. The plastic material allows the two screen meshes 128 to facilitate the extraction of honey from the wax capping without interfering with the flow of honey or compromising the efficiency of the extraction process.

FIG. 3C refers to a schematic view of the second frame assembly 104 with a snap-fit mechanism. In one embodiment herein, the secondary frame member 122 is formed with a cavity 127 that is specifically dimensioned and contoured to accommodate honey capping material. The cavity 127 is configured to receive honey cappings that are manually inserted by the user, thereby enabling convenient collection, temporary storage, or processing of the cappings within the structural confines of the secondary frame member 122. This arrangement facilitates ease of use, improves handling efficiency, and helps maintain the honey cappings in a controlled and accessible position during operation.

In one embodiment herein, the plurality of coupling members 124 is detachably attached to the plurality of snap bulges 126, providing a snap-fit mechanism. This snap-fit mechanism offers an easy and secure way to access the wax capping. By allowing the user to quickly detach and reattach the primary frame member 120 and secondary frame member 122, the snap-fit mechanism simplifies the handling of the wax capping during the honey extraction process. The snap-fit mechanism ensures that the primary frame member 120 and secondary frame member 122 are securely connected during the honey extraction process, preventing any movement or dislodgement of the components.

FIG. 4 refers to a flowchart 400 of extracting the honey from the wax capping by utilizing the second frame assembly 104. At step 402, the user manually inserts the wax capping within the cavity 127 of the secondary frame member 122. At step 404, the user positions the primary frame member 120 on the secondary frame member 122, thereby allowing the snap-fit mechanism by the plurality of coupling members 124 to be detachably attached to the plurality of snap bulges 126. At step 406, the user manually positions the second frame assembly 104 within the honey extraction machine to extract the honey from the wax capping. Further, at step 408, the at least two screen meshes 128 filter the honey from the wax cappings during the honey extraction process, ensuring a cleaner separation. After extracting the honey, the primary frame member 120 is removed from the secondary frame member 122 and the cleaned wax cappings are taken out.

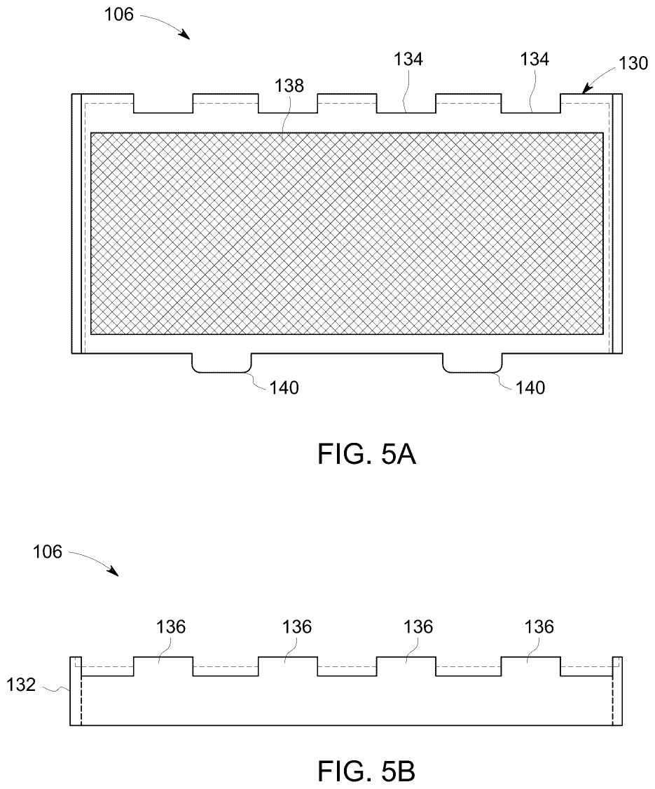

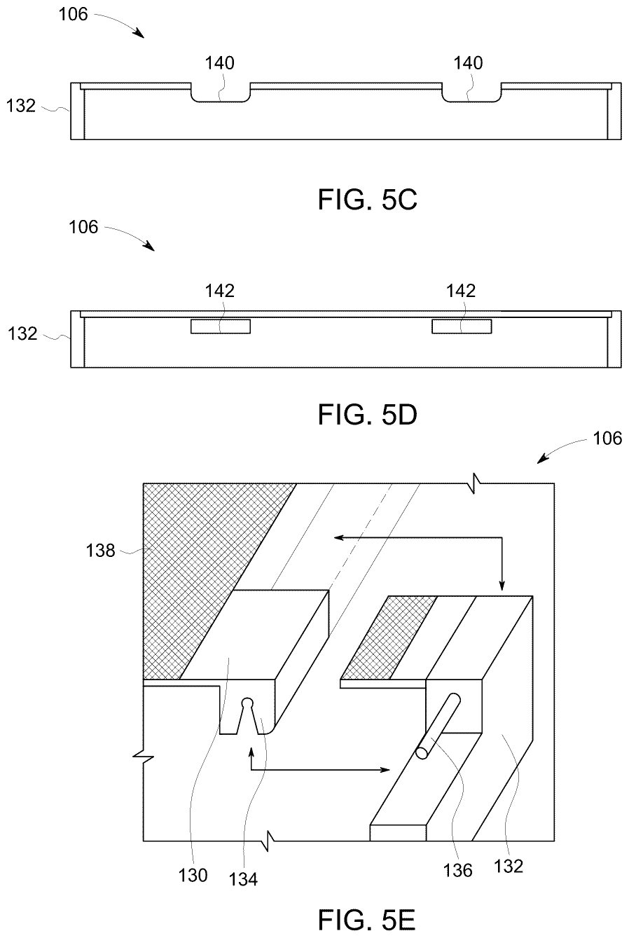

FIG. 5A refers to a top schematic view of a third frame assembly 106. In one embodiment herein, the third frame assembly 106 comprises a first frame member 130 and a second frame member 132. The first frame member 130 is equipped with a plurality of hinge barrels 134. These hinge barrels 134 are configured to facilitate interaction with a hinge rod 136 of the second frame member 132, providing structural support and enabling connection with the second frame member for the honey extraction process. The first frame member 130 and a second frame member 132 are designed with specific dimensions, at least 2 inches thick by at least 8 inches wide by at least 18 inches long. These dimensions are optimized to provide a compact yet effective structure for the honey extraction process.

The first frame member 130 is equipped with a plurality of gripping members 140. These gripping members 140 are configured to securely interact with latch members 142 of the second frame member 132. When the gripping members 140 engage with the latch members 142, they effectively secure the first frame member 130 and the second frame member 132 together. This secure connection ensures that the frame members stay properly aligned and stable while honey is being extracted from the wax capping, preventing any movement that could interfere with the process. The first frame member 130 and second frame member 132 are designed with specific dimensions, at least 2 inches thick by at least 8 inches wide by at least 18 inches long. These dimensions are optimized to fit into the honey extractor machine for the honey extraction process.

FIG. 5B refers to a right-side schematic view of the third frame assembly 106. FIG. 5C refers to a left-side schematic view of the third frame assembly 106. In one embodiment herein, the first frame member 130 is equipped with the plurality of hinge barrels 134. These hinge barrels 134 are configured to facilitate interaction with the second frame member 132, providing structural support and enabling connection with the second frame member for the honey extraction process. The second frame member 132 is configured with a plurality of hinge rods 136. These hinge rods 136 are pivotally connected to the first frame member 130 via the plurality of hinge barrels 134. This pivotal connection allows for flexibility and movement, making it easier to handle the wax capping during the honey extraction process. The second frame member 132 is specifically configured to receive the wax capping, which is essential for extracting honey efficiently and cleanly. Additionally, the dashed lines represent either of plurality of hinge barrels 134 or the hinge rods 136, which pivotally connect the first frame member 130 to the second frame member 132.

The first frame member 130 and the second frame member 132 are equipped with a filter member 138. The filter member 138 ensures a cleaner separation of honey from the solids. This process is the use of ‘food-grade’ plastic in the screen and other processing equipment, which helps maintain the highest food safety standards, thereby ensuring that the honey remains safe for consumption throughout the entire removal process. By filtering these unwanted particles, the filter member 138 ensures that the honey extracted remains pure and free from impurities. In another embodiment herein, the filter member 138.

In one embodiment herein, the filter member 138 is made from a plastic material, which is chosen for its durability and ability to withstand the conditions associated with the honey extraction process. The use of plastic material ensures that the filter member 138 is both effective at filtering and resistant to degradation or wear, thus facilitating smooth and efficient honey extraction. In one embodiment herein, the first frame member 130 is equipped with the plurality of gripping members 140. The gripping members 140 are configured to securely interact with latch members 142 of the second frame member 132.

When the gripping members 140 engage with the latch members 142, they effectively secure the first frame member 130 and the second frame member 132 together. This secure connection ensures that the frame members stay properly aligned and stable while honey is being extracted from the wax capping, preventing any movement that could interfere with the process. In one example, the gripping members 140 are attached to the latch members 142 on the second frame member 132. The latch members 142 work in conjunction with the gripping members 140 to create a secure and easily detachable connection between the first frame member 130 and the second frame member 132.

FIG. 5D refers to a right-side schematic view of the third frame assembly 106. In one embodiment herein, the third frame assembly 106 is configured as a generally rectangular frame structure adapted to fit within a conventional honey extraction machine. Additionally, the first frame member 130 forms the upper structural portion of the assembly and extends longitudinally across the length of the third frame assembly 106. The first frame member 130 is configured to align flush with the outer side surfaces of the second frame member 132 when assembled, thereby forming a substantially continuous sidewall profile that prevents lateral displacement of wax cappings during centrifugal operation. The second frame member 132 forms the lower structural portion. The sidewall of the secondary frame member 132 is shown as substantially planar and vertically oriented, providing structural rigidity and containment for the wax cappings during extraction.

At least one gripping member 140 is formed integrally with or secured to the first frame member 130 and is positioned to engage a corresponding snap bulge or receive the latch member 142 formed on the second frame member 132. The latch member 142 is configured as a laterally projecting retention feature that cooperates with the gripping member 140 to provide a snap-fit engagement. Upon downward positioning of the first frame member 130 onto the second frame member 132, the gripping member 140 elastically deflects and then seats against the latch member 142, thereby securing the two frame members together. The snap-fit engagement is configured to resist separation during centrifugal rotation within the honey extractor, while still permitting manual disengagement after extraction for removal of the wax cappings. The alignment of the first frame member 130 with the side edges of the second frame member 132 further provides a containment function, preventing wax material from being forced outward between the frame interfaces during operation.

FIG. 5E refers to a schematic view of the third frame assembly 106 with a snap-fit mechanism. In one embodiment, the plurality of gripping members 140 formed on the first frame member 130 are configured to releasably engage with a corresponding plurality of latch members 142 formed on the second frame member 132. The gripping members 140 and latch members 142 are dimensioned and contoured to provide an interference-type mechanical engagement, whereby elastic deformation of at least one of the interacting members permits snap-in coupling when the first frame member 130 is moved into a closed position relative to the second frame member 132.

In one embodiment, each gripping member 140 includes an outwardly projecting retention surface configured to ride over a complementary cam surface of a corresponding latch member 142 during closure. Upon full engagement, the retention surface of the gripping member 140 seats behind a locking shoulder of the latch member 142, thereby establishing a positive mechanical lock. This snap-fit arrangement allows the first frame member 130 and the second frame member 132 to be detachably secured without the use of separate fasteners, tools, or auxiliary locking hardware.

The snap-fit mechanism is configured to provide sufficient retention force to maintain the structural integrity of the third frame assembly 106 during centrifugal rotation within a honey extraction machine. Specifically, the engagement between the gripping members 140 and latch members 142 resists separation forces generated by rotational acceleration and the mass of wax cappings contained within the assembly. At the same time, the snap-fit configuration permits intentional manual disengagement by the user after completion of the honey extraction process, thereby enabling convenient opening of the frame assembly and removal of the separated wax cappings. The first frame member 130 is formed with the hinge barrels 134 as in a rounded pivot surface that cooperates with the hinge rod 126 to permit rotational movement of the first frame member 130 relative to the second frame member 132, thereby enabling controlled pivotal opening and closing of the third frame assembly 106.

By enabling rapid attachment and detachment of the first frame member 130 and the second frame member 132, the snap-fit mechanism enhances operational efficiency, reduces handling time, and facilitates post-extraction cleaning of the frame components. The releasable engagement further prevents unintended displacement, misalignment, or separation of the frame members during operation, ensuring consistent containment of the wax cappings and reliable honey extraction performance.

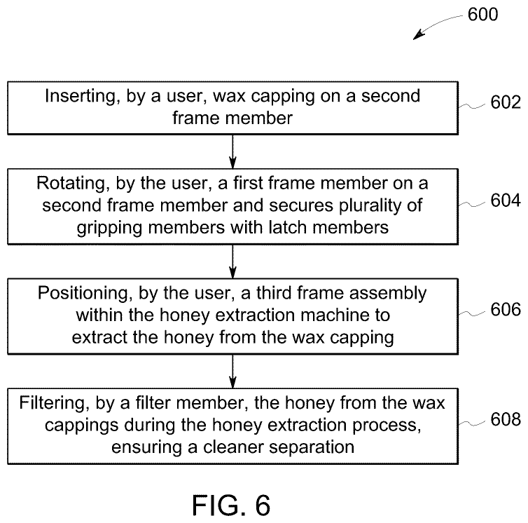

FIG. 6 refers to a flowchart 600 of a method for extracting the honey from the wax capping by utilizing the third frame assembly 106. At step 602, the user manually inserts the wax capping on the second frame member 132. At step 604, the user rotates the first frame member 130 on the second frame member 132 and secures the plurality of gripping members 140 with the latch members 142. At step 608, the user manually positions the third frame assembly 106 within the honey extraction machine to extract the honey from the wax capping. Further, at step 610, the filter member 138 filters the honey from the wax cappings during the honey extraction process, ensuring a cleaner separation.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A wax-capping honey separation device, comprising:
a first frame assembly having a structural frame,
wherein the structural frame defines a hollow structure configured to receive wax cappings containing residual honey;
at least two mesh members disposed on opposite sides of the structural frame, wherein the at least two mesh members are configured to permit honey to pass outwardly from the hollow structure during centrifugal extraction while retaining the wax cappings within the hollow structure;
at least two grooves formed along opposite sides of the structural frame, wherein each of the grooves defining a respective side track; and
at least two sliders slidably received within the respective grooves of the structural frame, wherein the at least two sliders are configured to allow a user to be selectively translated between an open position that permits insertion of wax cappings into the hollow structure and a closed position that seals the hollow structure during centrifugal extraction,
whereby, during centrifugal extraction, honey passes through the mesh members while the wax cappings remain retained within the hollow structure.

2. The device of claim 1, wherein the at least two grooves are integrally formed with the structural frame and extend longitudinally along opposing sides of the structural frame.

3. The device of claim 1, wherein the at least two sliders are positioned on opposite sides of the structural frame such that wax cappings are insertable into the hollow structure from either side of the structural frame.

4. The device of claim 1, wherein each of the sliders comprises at least one notch configured to receive a user's fingertip to facilitate manual translation of the sliders between the open position and the closed position.

5. The device of claim 1, wherein the at least two mesh members comprise at least one of stainless-steel mesh, food-grade polymer mesh, molded perforated screening, and perforated sheet material.

6. The device of claim 1, wherein the sliders are removably received within the grooves such that the sliders are removable after centrifugal extraction to permit manual removal of wax cappings from the hollow structure.

7. A wax-capping honey separation device, comprising:
a first frame assembly having a structural frame,
wherein the structural frame defines a hollow structure configured to receive wax cappings containing residual honey;
at least two mesh members disposed on opposite sides of the structural frame, wherein the at least two mesh members are configured to permit honey to pass outwardly from the hollow structure during centrifugal extraction while retaining wax cappings within the hollow structure;
at least two grooves formed along opposite sides of the structural frame, wherein each of the grooves defines a respective side track; and
at least two sliders slidably received within respective grooves of the structural frame, wherein the at least two sliders are configured to allow a user to move between an open position for loading wax cappings into the hollow structure and a closed position for sealing the hollow structure,
wherein each of the sliders comprises at least two notches configured to allow a user's fingertip to selectively translate the sliders between the open position and the closed position, such that the wax-capping honey separation device separates honey from wax cappings during centrifugal extraction while maintaining the wax cappings retained within the hollow structure for subsequent removal.

8. The device of claim 7, wherein the mesh members comprise molded perforations integrally formed within the structural frame.

9. The device of claim 7, wherein the at least two mesh members comprise at least one of stainless-steel mesh, food-grade polymer mesh, or perforated screening.

10. The device of claim 7, wherein each of the at least two mesh members is fixedly disposed within a corresponding opening of the structural frame.

11. The device of claim 7, wherein the grooves are integrally formed within the structural frame.

12. The device of claim 7, wherein the sliders are removable from the grooves after centrifugal extraction to permit manual expulsion of wax cappings from the hollow structure.

13. A method for separating honey from wax cappings using a device, comprising:
moving, by a user, sliders from a closed position to an open position to access a hollow structure of a structural frame;
inserting, by the user, wax cappings into the hollow structure of the structural frame;
moving, by the user, the sliders from the open position to the closed position to seal the hollow structure;
positioning, by the user, a first frame assembly of the device within a honey extraction machine; and
allowing honey to pass through one or more mesh members while retaining the wax cappings within the hollow structure during operation of the honey extraction machine.
